(19) United States
(12) Patent Application Publication
(10) Pub. No.: US 2011/0025252 A1
(43) Pub. Date: Feb. 3, 2011

(54) STEPPING MOTOR DRIVE APPARATUS AND STEPPING MOTOR DRIVING METHOD

(76) Inventor: Toru KAWABATA, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/835,918

(22) Filed: Jul. 14, 2010

(30) Foreign Application Priority Data
Jul. 15, 2009 (JP) 2009-166537

(51) Int. Cl. H02P 8/22

(52) U.S. Cl. 318/696

(57) ABSTRACT

In order to provide a stepping motor drive apparatus and a stepping motor driving method that attain a constant rotation angle per step at every angular position despite variations in load and that are free of rotational fluctuation, a drive control unit of a stepping motor drive apparatus drives a driving coil of one phase of a stepping motor (11) with a first drive signal (DS1) having a first absolute value, and at the same time, drives a driving coil of the other phase of the stepping motor with a second drive signal (DS2) having a second absolute value. The first absolute value and the second absolute value each have a value being different from each other's, and a ratio (d) between the first absolute value and the second absolute value is constant.

### BACKGROUND OF THE INVENTION

1. Technical Field

The present invention relates, to a drive apparatus and a driving method for a stepping motor used as a drive source for achieving accurate positioning.

2. Background Art

A stepping motor includes driving coils of a plurality of phases. Excitation of the driving coils holds the rotary shaft of the stepping motor at an accurate angular position. Further, execution of drive control for sequentially switching the excitation states of the driving coils allows the rotary shaft to rotate exactly by a constant angle, and to rotate exactly by a specific angular position and to hold there. Further, execution of control over the excitation switching rate of the driving coils makes it possible to freely change the number of rotation. Here, it is possible to achieve a relatively fast rotation of about 6000 min⁻¹.

What is carried out in optical drive apparatuses for CDs, DVDs, Blu-ray Discs and the like for recording and reproducing data is a seek operation, in which an optical pickup is shifted in the disc radial direction is carried out. The seek operation of the optical pickup is required to achieve fast shifting at about 100 mm/s, in view of the seek speed and the access time. It is also required to achieve accurate positioning of about ±50 μm, taking into consideration of the lens shift characteristic of an objective lens.

The seek operation of such an optical pickup in any optical drive apparatus can be supported by the characteristics of stepping motors, such as exact positioning, exact rotation speed control, and fast speed. Therefore, stepping motors are often used in optical drive apparatuses.

Such stepping motors are also frequently used, in addition to the optical drive apparatuses, for mechanisms that must be shifted at high precision and high speed, such as paper feed or carriage shift in a printer apparatus.

Generally, the majority of the stepping motors employed for performing the seek operation belong to a so-called two-phase PM type (permanent magnet type). Such a PM type stepping motor has a structure in which two phase sets of coils being perpendicular to each other in terms of electrical angle are arranged around a rotor of a permanent magnet. For driving the PM type stepping motor, a driving method referred to as a two-phase drive mode is frequently used. However, for the purpose of positioning the optical pickup, in some cases, the two-phase drive mode driving method fails to provide sufficient position resolution. In such cases, a driving method referred to as a 1-2 phase drive mode is used.

In the two-phase drive mode driving method, two phase sets of coils are constantly energized to drive the rotor. On the other hand, in the 1-2 phase drive mode driving method, two energization modes are alternately performed to drive the rotor, the former mode being energization of two phase sets of coils, and the latter mode being energization of one phase set of coils. The 1-2 phase drive mode driving method makes it possible to stop the rotor also at a step angle position just half a step angle achievable by the two-phase drive mode driving method. Thus, the resolution can be doubled. It is to be noted that, hereinafter, the state in which the two phase sets of coils are energized is referred to as the two-phase excitation mode, and the state in which the one phase set of coils is solely energized is referred to as the one-phase excitation mode.

One index related to the positioning precision of the stepping motor is a characteristic referred to as “the stiffness characteristic”. Detailed description of the stiffness characteristic will be given later. When the rotor has its angle displaced by an external force from an angular position which the stepping motor is urged to hold in an unloaded state, torque that urges to recover the original holding position is produced in an amount commensurate with the displaced angle. Such a relationship between the torque and the displaced angle is defined as “the stiffness characteristic”. Hereinafter, the torque that urges to recover the original holding position is referred to as “the produced torque” for the sake of convenience. Normally, the produced torque increases in accordance with an increase in the displaced angle until the displaced angle reaches a certain angle.

The stiffness characteristic does not affect the positioning precision when totally unloaded. However, practically, the positioning operation is mostly performed under some loads. In such cases, the stiffness characteristic has a great effect on the positioning precision.

For example, when the rotor rotates while overcoming a certain amount of friction torque and to be positioned at a certain angle, the rotor cannot be stopped at the same angular position as in the unloaded state. The rotor in such a case is stopped at a displaced angular position where the produced torque balances with the friction torque. Accordingly, with a motor that produces great produced torque with a small displaced angle, a small displaced angle brings about a sufficiently great produced torque that balances with the friction torque, whereby the rotor is stopped at an angular position with small displacement. Accordingly, the angular position at which the rotor is stopped approximates the angular position where the rotor is stopped when unloaded. Thus, it becomes possible to improve the positioning precision.

It is to be noted that, different types of relationship between the displaced angle and the produced torque, i.e., different stiffness characteristics, provide different actually stopping positions, even when an attempt to position the rotor at the same position is made with the same friction torque.

In the 1-2 phase drive mode driving method, there exist the one-phase excitation state and the two-phase excitation state, which alternate. The two excitation states are originally different in the number of energized driving coils and, therefore, they are intrinsically different in the relationship between the displaced angle and the produced torque. Therefore, when there is any load such as the friction torque, even in the same 1-2 phase drive mode, the one-phase excitation state and the two-phase excitation state provide positioning errors different from one another's.

In the 1-2 phase drive mode driving method, for example, even when an attempt is made to drive the rotor in the 1-2 phase drive mode by a constant angle, the rotor is not driven at such a constant angle, but a rotational fluctuation is invited, in which a great amount of shift and a small amount of shift are repeatedly performed.

Accordingly, when the 1-2 phase drive mode driving method is used, e.g., for the paper feed mechanism of a printer apparatus, it directly leads to defectiveness such as uneven printing, which impairs the printing quality. In order to avoid such a situation, a paper feed mechanism that is free of the rotational fluctuation and capable of evenly moving the paper is preferable, even if its absolute value of the positioning error is great.

When the stepping motor is used as a drive source of the seek operation, high positioning precision is required for shifting the optical pickup to the position that falls within a range of permissible amount of the lens shift of the optical pickup with respect to the track being the target of recording or reproducing. Here, the lens shift amount is constantly measured, and when the lens shift amount exceeds the permissible value, the stepping motor is driven to attain the permissible value. Accordingly, what is important is the evenness of the shift amount when the stepping motor is driven, and the greatness of the absolute value of the positioning error does not pose much problem.

In order to overcome the problems described above, conventional techniques propose a method to change the drive current between the one-phase excitation state and the two-phase excitation state, such that the produced torque produced in the one-phase excitation state equals that produced in the two-phase excitation state (for example, see Japanese Unexamined Patent Application Publication Nos. 2000-125595, 06-054589, 09-098599, and 2007-066451).

Another proposed method is to create the two-phase excitation state in part of the one-phase excitation state, to thereby correct the error (for example, see Japanese Unexamined Patent Application Publication No. 11-275895).

FIG. 7A shows the drive voltage waveforms in a conventional stepping motor drive apparatus disclosed in Japanese Unexamined Patent Application Publication No. 2000-125595. The conventional stepping motor of the stepping motor drive apparatus disclosed in Japanese Unexamined Patent Application Publication No. 2000-125595 has driving coils of two phases, namely coil A and coil B.

In the conventional stepping motor drive apparatus disclosed in Japanese Unexamined Patent Application Publication No. 2000-125595, because the supply voltage is 12 V, the applied maximum voltage is 12 V. Though the drive torque produced in the motor is proportional to current, the current-controlled mode somewhat complicates the circuitry. In addition, in a case where preciseness is required, the number of rotation is very small, and the drive current is almost determined by the drive voltage/a coil DC resistance. Therefore, the voltage-controlled mode is employed.

The drive waveforms shown in FIG. 7A have eight drive states denoted by “1a” to “8a”. Among the eight states, in the drive states denoted by “1a”, “3a”, “5a”, and “7a”, the drive voltage of either the coil A or the coil B is zero (0) V, which means they each are the aforementioned one-phase drive state. In each of these one-phase drive states, the other coil to which the drive voltage is applied is supplied with a maximum voltage of ±12 V.

On the other hand, the drive states denoted by “2a”, “4a”, “6a”, and “8a” each correspond to the two-phase drive state in which the drive voltage is applied to both the coil A and the coil B. In the normal 1-2 phase drive mode, in the two-phase drive state, a maximum voltage of 12 V as in the case of the one-phase excitation mode is applied to both of the coils. The drive states in the normal 1-2 phase drive mode is represented by broken lines “2a′”, “4a′”, “6a′”, and “8a′” in FIG. 7A. In the conventional stepping motor drive apparatus disclosed in Japanese Unexamined Patent Application Publication No. 2000-125595, it is described that the drive voltage of the two-phase drive state is 8.4 V, which is the voltage 70% as great as the drive voltage of the one-phase drive state.

FIG. 7B is a diagram showing drive vectors of the conventional stepping motor drive apparatus disclosed in Japanese Unexamined Patent Application Publication No. 2000-125595.

The drive vectors shown in FIG. 7B are vectors that each represent the direction and magnitude of force generated at the rotor by the coils A and B through which the drive current passed. The directions of the vectors are of a timing at which the rotor is finally stabilized and stopped in an unloaded state.

Generally, with a stepping motor, in a state shown in FIG. 7B, the vectors are completely directed in the radial direction, and do not externally produce torque. Further, in FIG. 7B, the directions of the vectors correspond to the positioning angles in an unloaded state. The vectors in the one-phase excitation mode are directed in the directions of excited coils. That is, the direction of force in a state where solely the coil A is excited with (+12 V) (the drive state denoted by “1a”) is represented on the A-phase+direction axis (+horizontal axis) in FIG. 7B. Similarly, the direction of force in a state where solely the coil B is excited with (+12 V) (the drive state denoted by “3a”) is represented on the B-phase+direction axis (+vertical axis) in FIG. 7B.

In the stepping motor of the conventional stepping motor drive apparatus disclosed in Japanese Unexamined Patent Application Publication No. 2000-125595, though the direction of force that is generated at the rotor when the driving coil being the coil A is excited and that generated at the rotor when the driving coil being the coil B is excited actually form a mechanical angle of 18° between them, this is shown as 90° in FIG. 7B.

As shown in FIG. 7B, in the two-phase excitation mode, what are produced are resultant vectors each made up of the vectors respectively generated by the excited coils A and B of two phases.

As described in the foregoing, when an external force is applied to the rotor in any drive state shown in FIG. 7B in an attempt to displace the rotor from the positioning angle at that timing, torque is produced in the direction that urges the rotor to return. As described in the foregoing, the produced torque normally increases in accordance with an increase in the displaced angle until the displaced angle reaches a certain angle. It is further noted that the greater the vector, the greater the produced torque.

In FIG. 7B, the vectors of the drive states denoted by “1a” to “8a” and the drive states denoted by “2a′”, “4a′”, “6a′”, and “8a′” in the normal 1-2 phase drive mode appearing in the drive waveforms in FIG. 7A, are denoted by the same reference characters.

As can clearly be seen from FIG. 7B, respective vector lengths of “2a′”, “4a′”, “6a′”, and “8a′” in the two-phase drive mode in the normal 1-2 phase drive mode are longer than those of “1a”, “3a”, “5a”, and “7a” in the one-phase drive mode. Therefore, as described in the foregoing, it can be understood from the drive vector diagram of FIG. 7B that the rotation angle varies in the normal 1-2 phase drive mode driving method.

In the conventional stepping motor drive apparatus disclosed in Japanese Unexamined Patent Application Publication No. 2000-125595, the drive voltage in the drive states of the two-phase excitation state denoted by “2a”, “4a”, “6a”, and “8a” is about 8.4 V, which is 70% as great as the drive voltage (12 V) in the one-phase drive state. Accordingly, with the conventional stepping motor drive apparatus disclosed in Japanese Unexamined Patent Application Publication No. 2000-125595, the vector lengths of “2a”, “4a”, “6a”, and “8a” in the two-phase excitation state become approximately equal to the vector lengths of “1a”, “3a”, “5a”, and “7a” in the one-phase excitation state. Consequently, the produced torque corresponding to the same displaced angle assumes a substantially constant value, and the displaced angle under the same load assumes a substantially constant value. Therefore, the conventional stepping motor drive apparatus disclosed in Japanese Unexamined Patent Application Publication No. 2000-125595 is configured to suppress occurrence of great rotational fluctuation.

However, the configuration of the conventional stepping motor drive apparatus such as described above suffers the following problems.

The first problem lies in that, it is impossible to actually equalize the vector lengths in each drive state in which only the one phase set of coils is energized (one-phase excitation mode) and the vector lengths in each drive state in which two phase sets of coils are energized (two-phase excitation mode). Further, in a case where a stepping motor is employed, the normal excitation current is often used in a state where the yoke of the magnetic circuit saturates. Therefore, the vector length is not proportional to the excitation current, and the holding force cannot be equalized just by employing an excitation current reduced to 70%.

The second problem lies in that the stiffness characteristic described above is not engaged in a simple proportional relationship, and that the characteristic curve of the drive state in which only one phase set of coils is energized and that of the drive state in which two phase sets of coils are energized form totally different curves from each other's. Provided that adjustment of the excitation current allows the characteristics of respective states to form an identical characteristic curve, then, by adjusting the excitation current using any method so as to obtain an identical holding torque corresponding to a certain displaced angle, the displaced angle in both states will be identical even under varying load, and the rotation angle variation will not occur.

However, because those driving states actually form totally different characteristic curves as described above, such adjustment of the excitation current cannot allow them to form the identical characteristic curve. Consequently, even if the excitation current is adjusted using any method in an unloaded state or under a specific load such that identical holding torque corresponding to a certain displaced angle is derived, the displaced angle in each of the driving states will differ under varying load, because the driving states are different in characteristic. As a result, there arises a problem that the rotational fluctuation occurs in a situation of varying load.

### SUMMARY OF THE INVENTION

The object of the present invention is to solve the problems associated with the two-phase drive mode and the 1-2 phase drive mode described in the foregoing, and to provide a stepping motor drive apparatus and a stepping motor driving method that attain a constant rotation angle per step at every angular position despite variations in load and that are free of rotational fluctuation.

In order to solve the problems associated with the conventional stepping motor drive apparatus and to achieve the object of the present invention, a stepping motor drive apparatus according to a first aspect of the present invention is a stepping motor drive apparatus including a drive control unit that controls a drive mode of a stepping motor including driving coils respectively belonging to two phases. The drive control unit is configured to control the drive mode of the stepping motor by applying a first drive signal having a first absolute value to a driving coil belonging to one phase out of the driving coils respectively belonging to the two phases, and applying a second drive signal having a second absolute value to a driving coil belonging to other phase out of the driving coils respectively belonging to the two phases. The first absolute value and the second absolute value each have a value different from each other's, and a ratio between the first absolute value and the second absolute value is constant. With the stepping motor drive apparatus according to the first aspect of the present invention configured as described in the foregoing, when adjustment is carried out in an unloaded state or under a specific load such that identical holding torque corresponding to a displaced angle at every step position is derived, because the characteristic curve at every step position is identical, the identical displaced angle is attained at every step position even under varying load. Thus, the occurrence of rotational fluctuation can be prevented.

In a stepping motor drive apparatus according to a second aspect of the present invention, the ratio between the first absolute value and the second absolute value according to the first aspect in an unloaded state is set to achieve a constant rotation angle per step at every angular position in the stepping motor.

In a stepping motor drive apparatus according to a third aspect of the present invention, a step position in the stepping motor according to the first aspect is at an angular position displaced by −22.5° and +22.5° in electrical angle from an angular position when only the driving coil belonging to the one phase is excited in the unloaded state, and at an angular position displaced by −22.5° and +22.5° in electrical angle from an angular position when only the driving coil belonging to the other phase is excited in the unloaded state.

In a stepping motor drive apparatus according to a fourth aspect of the present invention, the first absolute value and the second absolute value according to the first aspect are variable values, and the ratio between the first absolute value and the second absolute value is adjusted in accordance with a characteristic of the stepping motor.

A stepping motor drive apparatus according to a fifth aspect of the present invention further includes an adjustment apparatus that adjusts the ratio in accordance with a usage state of the stepping motor according to the first aspect.

In a stepping motor drive apparatus according to a sixth aspect of the present invention, the drive control unit according to the first aspect is configured to control the drive mode of said stepping motor by switching between a two-phase drive mode and a microstep drive mode in accordance with number of rotation, precision of a rotation angular position, and drive torque of said stepping motor.

A stepping motor driving method according to a seventh aspect of the present invention is a stepping motor driving method of controlling a drive mode of a stepping motor including driving coils respectively belonging to two phases, including a step of controlling the drive mode of the stepping motor by applying a first drive signal having a first absolute value to a driving coil belonging to one phase out of the driving coils respectively belonging to the two phases, and applying a second drive signal having a second absolute value to a driving coil belonging to other phase out of the driving coils respectively belonging to the two phases. The first absolute value and the second absolute value each have a value different from each other's, and a ratio between the first absolute value and the second absolute value is constant. With the stepping motor driving method according to the seventh aspect of the present invention driven as described in the foregoing, when adjustment is carried out in an unloaded state or under a specific load such that identical holding torque corresponding to a displaced angle at every step position is derived, because the characteristic curve at every step position is identical, the identical displaced angle is attained at every step position even under varying load. Thus, the occurrence of rotational fluctuation can be prevented.

In a stepping motor driving method according to an eighth aspect of the present invention, the ratio between said first absolute value and said second absolute value according to the seventh aspect in an unloaded state is set to achieve a constant rotation angle per step at every angular position in said stepping motor.

In a stepping motor driving method according to a ninth aspect of the present invention, a step position in the stepping motor according to the seventh aspect is at an angular position displaced by −22.5° and +22.5° in electrical angle from an angular position when only the driving coil belonging to the one phase is excited in the unloaded state, and at an angular position displaced by −22.5° and +22.5° in electrical angle from an angular position when only the driving coil belonging to the other phase is excited in the unloaded state.

In a stepping motor driving method according to a tenth aspect of the present invention, the first absolute value and the second absolute value according to the seventh aspect are variable values, and the ratio between the first absolute value and the second absolute value is adjusted in accordance with a characteristic of the stepping motor.

In a stepping motor driving method according to an eleventh aspect of the present invention, the step of controlling the drive mode of the stepping motor according to the seventh aspect is performed by switching between a two-phase drive mode and a microstep drive mode in accordance with number of rotation, precision of a rotation angular position, and drive torque of the stepping motor.

As described in the foregoing, according to the present invention, it becomes possible to obtain a stepping motor drive apparatus and a stepping motor driving method that attain a constant rotation angle per step at every angular position despite variations in load and that are free of rotational fluctuation.

### BRIEF DESCRIPTION OF DRAWINGS

FIG. 1 is a schematic diagram showing the overall configuration of a stepping motor drive apparatus according to a first embodiment of the present invention;

FIG. 2A shows an exemplary drive pattern when a stepping motor is driven to rotate by the stepping motor drive apparatus according to the first embodiment of the present invention;

FIG. 2B shows exemplary drive waveforms when the stepping motor is driven to rotate by the stepping motor drive apparatus according to the first embodiment of the present invention;

FIG. 3 shows drive vectors of the stepping motor, drive apparatus according to the first embodiment of the present invention;

FIG. 4 is a characteristic graph showing the stiffness characteristic of the stepping motor of the stepping motor drive apparatus according to the first embodiment of the present invention;

FIG. 5 shows the operation (excitation) state in the 1-2 phase excitation drive mode with a conventional stepping motor drive apparatus;

FIG. 6 shows the operation (excitation) state in the identical ratio excitation driving method performed with the stepping motor drive apparatus according to the first embodiment of the present invention;

FIG. 7A is a waveform diagram showing the drive voltage waveforms of the conventional stepping motor drive apparatus; and

FIG. 7B is a diagram showing drive vectors of the conventional stepping motor drive apparatus.

### DETAILED DESCRIPTION OF THE INVENTION

With reference to the drawings, an embodiment for practicing the present invention will be described. In the drawings, those elements achieving substantially identical configuration, operation, and effect are denoted by the identical reference characters. Further, the numerical values appearing in the following are exemplarily shown for the purpose of specifically describing the present invention, and the present invention is not limited by the numerical values exemplarily shown. Still further, the switching state expressed by ON state/OFF state are exemplarily shown for the purpose of specifically describing the present invention, and it is also possible to obtain an equivalent result by any different combination of the exemplarily shown logic levels or switching states. Still further, the connection relationship among the constituents are exemplarily shown for the purpose of specifically describing the present invention, and the connection relationship for realizing the function of the present invention is not limited thereto. Still further, though the following embodiment is configured using hardware and/or software, the configuration employing hardware can also be achieved employing software, and vice versa.

### First Embodiment

In the following, a preferable embodiment of the present invention will be described with reference to the accompanying drawings.

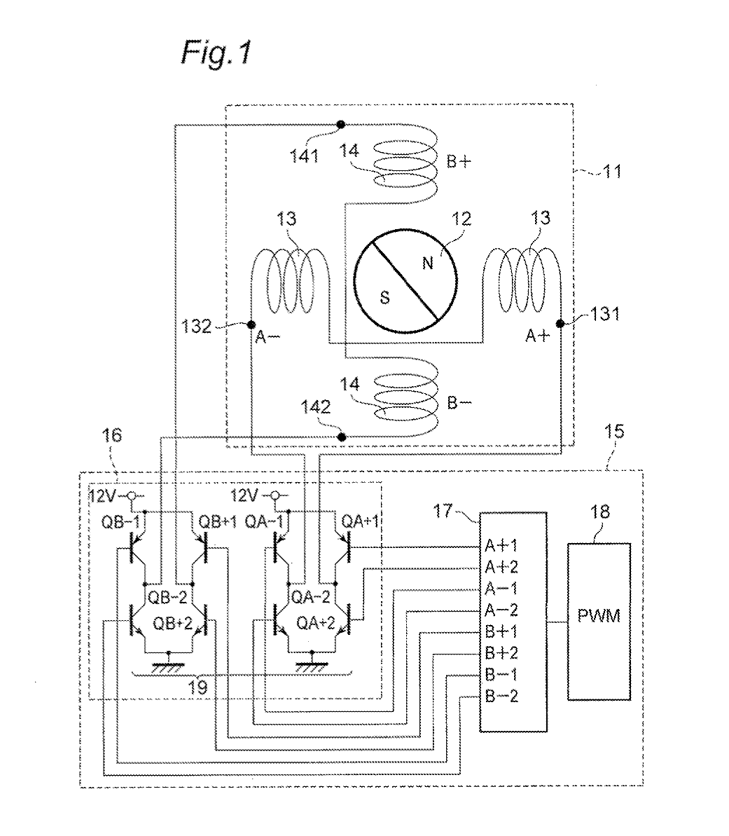

FIG. 1 shows the overall configuration of a stepping motor drive apparatus of a first embodiment according to the present invention. A stepping motor 11 being drive controlled by the stepping motor drive apparatus is what is called a two-phase PM type (permanent magnet type) stepping motor drive apparatus. The stepping motor 11 has a structure in which two phase sets of driving coils (coil A13 and coil B14) perpendicular to each other in terms of electrical angle are arranged about a permanent magnet rotor 12, to drive a not-shown load. The stepping motor 11 in FIG. 1 is schematically shown, and a step angle per step in the two-phase drive mode is 18° (mechanical angle). A drive control unit 15 that controls the drive mode of the stepping motor 11 is configured to include a drive unit 16, a sequence generation unit 17, and a PWM signal generation unit 18.

In the first embodiment of the present invention, a description will be given of a configuration in which a stepping motor drive apparatus that does not include a stepping motor. However, the present invention is not limited to such a configuration, but it may include a stepping motor drive apparatus configured to have a stepping motor. Further, though a description will be given solely of the drive control unit 15 in the stepping motor drive apparatus of the first embodiment, it is meant to show that the stepping motor drive apparatus of the present invention includes at least the drive control unit, and not to meant to exclude any other configuration generally employed for stepping motor drive apparatuses.

The sequence generation unit 17 generates eight types of signals “A+1”, “A+2”, “A−1”, “A−2”, “B+1”, “B+2”, “B−1”, and “B−2” in a predetermined order, and outputs them to the drive unit 16. In the drive unit 16, a transistor array 19 that includes eight transistors is controlled to switch between ON/OFF by the eight types of signals from the sequence generation unit 17. The transistor array 19 in the drive unit 16 is connected to a power supply of 12 V. In accordance with the output signals from the sequence generation unit 17, the transistor array 19 supplies current to the two phase sets of driving coils (coil A13 and coil 614) of the stepping motor 11, whereby the stepping motor 11 is driven to rotate.

The PWM signal generation unit 18 generates a PWM signal of a duty ratio d at a frequency of about 100 kHz, and outputs the generated PWM signal to the sequence generation unit 17. It is configured such that the duty ratio d can be adjusted as necessary. In the stepping motor drive apparatus of the first embodiment, the duty ratio d is set to approximately 0.41. The sequence generation unit 17 is configured to output the PWM signal to the drive unit 16 as necessary.

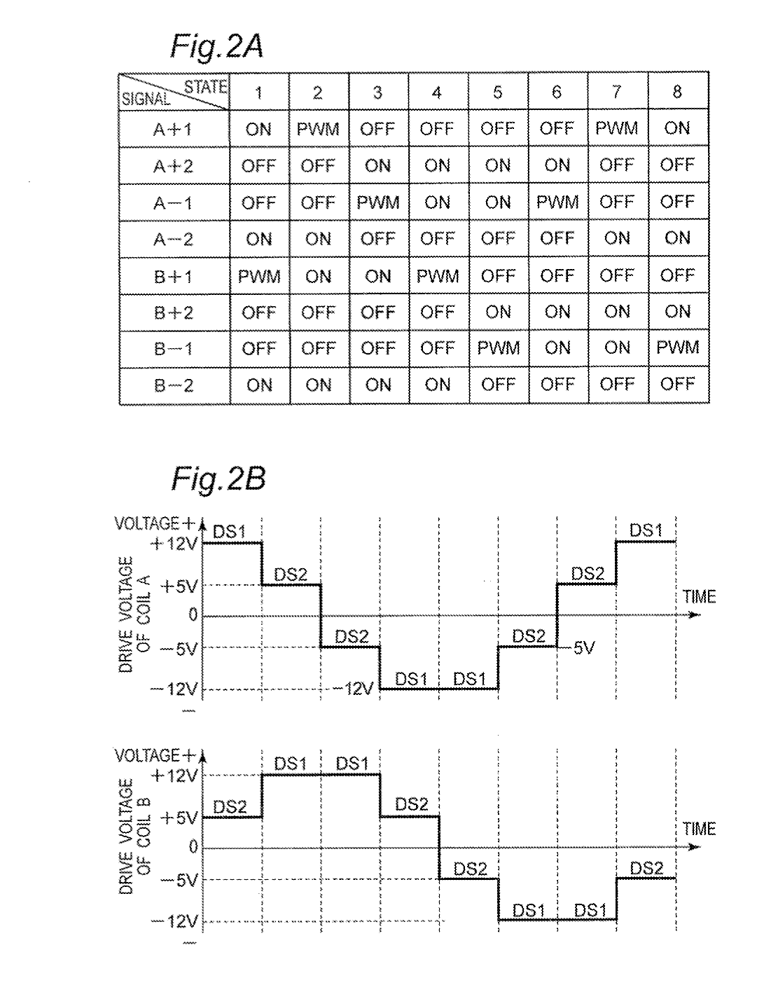

FIG. 2A shows an exemplary drive pattern when the stepping motor drive apparatus according to the first embodiment of the present invention drives the stepping motor 11 to rotate. FIG. 2B shows exemplary drive waveforms when the stepping motor drive apparatus according to the first embodiment drives the stepping motor 11 to rotate.

In the drive pattern of FIG. 2A, “ON” indicates that corresponding transistor in the transistor array 19 in the drive unit 16 is supplied with a base current enough to saturate, to enter an ON state. Similarly, “OFF” indicates that corresponding transistor in the transistor array 19 in the drive unit 16 is supplied with a base current of zero (0), to enter an OFF state. In the drive pattern of FIG. 2A, “PWM” indicates a PWM state in which an ON state and an OFF state alternate at a duty ratio d of about 100 kHz periodicity in accordance with the PWM signal output from the PWM signal generation unit 18. The sequence generation unit 17 sequentially outputs “state 1” to “state 8” by the outputs (“A+1”, “A+2”, “A−1”, “A−2”, “B+1”, “B+2”, “B−1”, and “B−2”) as shown in FIG. 2A, to thereby drive the stepping motor 11 to rotate.

In the following, a description will be given of the operation of the stepping motor drive apparatus according to the first embodiment of the present invention configured as described in the foregoing.

The sequence generation unit 17 generates eight types of signals from “A+1” to “B−2” in accordance with the drive pattern shown in FIG. 2A, to control the eight transistors in the transistor array 19 of the drive unit 16 to switch between ON/OFF.

The sequence generation unit 17 firstly outputs, for example, a signal of “state 1”. When the signal of “state 1” is output, in the transistor array 19, a transistor QA+1 is in an ON state, a transistor QA+2 is in an OFF state, a transistor QA−1 is in an OFF state, and a transistor QA−2 is in an ON state. Accordingly, the current flows in the following order: the power supply (12 V)→the transistor QA+1→an A+ terminal 131 of the coil A13→A→terminal 132 of the coil A13→the transistor QA−2→GND. Thus, the coil A13 is excited. Here, because the base current enough for the transistors in an ON state to saturate flows through them, the ON resistance thereof is a negligible value, and a supply voltage of 12 V is applied to the coil A13 as it is, to thereby excite the coil A13 to a maximum extent. In the following, the direction of current flowing from the terminal 131 to the A− terminal 132 in the coil A13 is referred to as the + direction current, and the reverse current is referred to as the − direction current.

Further, in the transistor array 19, a transistor QB+1 is in a PWM state, a transistor QB+2 is in an OFF state, a transistor QB−1 is in an OFF state, and a transistor QB−2 is in an ON state. Accordingly, the transistor QB+1 is alternately in ON/OFF state at a periodicity of 100 kHz by the PWM drive mode.

During the period in which the transistor QB+1 is in an ON state, the current flows in the following order: the power supply (12 V)→the transistor QB+1→the B+ terminal 141 of the coil B14→the B− terminal 142 of the coil B14→the transistor QB−2→GND. Thus, the coil B14 is excited. During the ON state period, because the base current enough for the transistors to saturate flows through them, the ON resistance thereof is a negligible value, and a supply voltage of 12 V is applied to the coil B14 as it is, to thereby excite the coil B14 to a maximum extent.

On the other hand, during a period in which the transistor QB+1 is in an OFF state, current does not flow through the coil B14. Because the periodicity in the PWM drive mode is 100 KH, which is short enough, an average current that is the same as in a case where a voltage of (supply voltage 12 V)×(duty ratio d) is applied flows through the coil B14, to excite the coil B14. Because the value of the duty ratio d is set to approximately 0.41, the coil B14 enters a state equivalent to that when a voltage of (12 V)×(0.41)≈5 V is applied.

Though the drive torque produced in the stepping motor 11 is proportional to current, the current-controlled mode somewhat complicates the circuitry. In addition, in a case where preciseness is required, the number of rotation is very small, and the current is almost determined by the drive voltage/the coil DC resistance. Therefore, the description will proceed based on the voltage-controlled mode. Accordingly, the drive torque produced in the stepping motor 11 is actually almost determined by the drive current derived from the drive voltage/the coil DC resistance.

After the “state 1” is held for a certain period (holding time), the next “state 2” is entered. The holding time depends on the operational state of the stepping motor 11. In a case where the stepping motor 11 is to be held at a constant angular position, the same state is maintained during the period it should be held. When it should be rotated, after the holding time commensurate to the number of rotation is held, the next states are sequentially entered.

In the configuration of the stepping motor 11 of the first embodiment, one step angle in the two-phase drive mode is 18°. Therefore, in the two-phase drive mode driving method, 20 steps achieve one complete rotation. In the driving method (identical ratio excitation driving method) for the stepping motor 11 of the first embodiment, as will be described later, 40 steps achieve one complete rotation. Accordingly, for example when it should be rotated at 1000 min the holding time will be 60/1000/40=0.0015 sec=1.5 ms.

Further, when the stepping motor 11 of the first embodiment is rotated, the order shown in FIG. 2A is repeatedly performed in the following order: state 1→state 2→state 3→state 4→state 5→state 6→state 7→state 8→state 1→state 2 → . . . . When it should just simply be rotated, this order may be started any one of “state 1” to “state 8”.

The rotation direction in the order noted above is counter-clockwise. When it should be rotated clockwise, the order should be reversed as follows: state 8→state 7→state 6→state 5→state 4→state 3→state 2→state 1→state 8→state 7→ . . . .

In a case where it should be rotated in the counter-clockwise direction, as described in the foregoing, after “state 1” is held, then “state 2” is entered.

In “state 2”, the transistor QA+1 in the transistor array 19 is in a “PWM state”, the transistor QA+2 is in an OFF state, the transistor QA−1 is in an OFF state, and the transistor QA−2 is in an ON state. Accordingly, the transistor QA+1 is alternately in ON/OFF state at a periodicity of 100 kHz by the PWM drive mode.

During the period in which the transistor QA+1 is in an ON state, the current flows in the following order: the power supply (12 V)→the transistor QA+1→the A+ terminal 131 of the coil A13→the A− terminal 132 of the coil A13→the transistor QA−2→GND. Thus, the coil A13 is excited. During the ON state period, because the base current enough for the transistors to saturate flows through them, the ON resistance thereof is a negligible value, and a supply voltage of 12 V is applied to the coil A13 as it is, to thereby excite the coil A13 to a maximum extent.

On the other hand, during a period in which the transistor QA+1 is in an OFF state, current does not flow through the coil A13. Because the periodicity in the PWM drive mode is 100 KHz, which is short enough, an average current that is the same as in a case where a voltage of (supply voltage 12 V)×(duty ratio d) is applied flows through the coil A13, to excite the coil A13. Because the value of the duty ratio d is set to approximately 0.41, the coil A13 enters a state equivalent to that when a voltage of (12 V)×(0.41)≈5 V is applied. In the following description, the voltage of about 5 V, i.e., (12 V)×(0.41)≈5 V, will be described as a voltage of “5 V” voltage.

Further, in “state 2”, in the transistor array 19, the transistor QB+1 is in an ON state, the transistor QB+2 is in an OFF state, the transistor QB−1 is in an OFF state, and the transistor QB−2 is in an ON state. Accordingly, the current flows in the following order: the power supply (12 V)→the transistor QB+1→the B+ terminal 141 of the coil B14→the B− terminal 142 of the coil B14→ the transistor QB−2→GND. Thus, the coil B14 is excited. Because the base current enough for the transistors in an ON state to saturate flows through them, the ON resistance thereof is a negligible value, and a supply voltage of 12 V is applied to the coil B14 as it is, to thereby excite the coil B14 to a maximum extent.

When it should further be rotated from “state 2” in the counter-clockwise direction, the operation following the operations of “state 3” and the following states are similarly repeatedly performed. As a result, it is driven in the waveforms as shown in FIG. 2B. FIG. 2B shows exemplary drive waveforms of the stepping motor drive apparatus according to the first embodiment of the present invention, which are the drive waveforms when continuous rotation in the counter-clockwise direction is carried out.

As can clearly be seen from the drive waveforms shown in FIG. 2B, the absolute value of the drive voltage of each of the coil A13 and the coil B14 is constantly “12 V” or “5 V”, and when the drive voltage of the coil A13 is “12 V”, the drive voltage of the coil B14 is “5 V”; when the drive voltage of the coil A13 is “5 V”, the drive voltage of the coil B14 is “12 V”. Thus, to the two sets of driving coils, as the absolute value of the drive voltage, voltages of “12 V” and “5 V” are constantly applied to drive the same. In the first embodiment, “12 V” is a first absolute value, and a signal of “12 V” is a first drive signal DS1. Further, “5 V” is a second absolute value, and a signal of “5 V” is a second drive signal DS2.

As described in the foregoing, though the drive torque produced in the stepping motor 11 is proportional to current, when preciseness is required, the number of rotation is very small, and the current is almost determined by the drive voltage/the coil DC resistance. Therefore, the current proportional to the ratio between the drive voltage and the coil DC resistance flows through the driving coils. In the first embodiment, a description is given taking up an example in which a voltage signal is used as the drive signal. However, the drive signal for the driving coil is virtually a current signal. Accordingly, the drive signals used in the present invention are the first drive signal (DS1) in which the drive current flowing through one of the two-phase sets of driving coils (for example, the coil A) has the first absolute value (I1), and the second drive signal (DS2) in which the drive current flowing through the other coil (for example, the coil B) has the second Absolute value (I2).

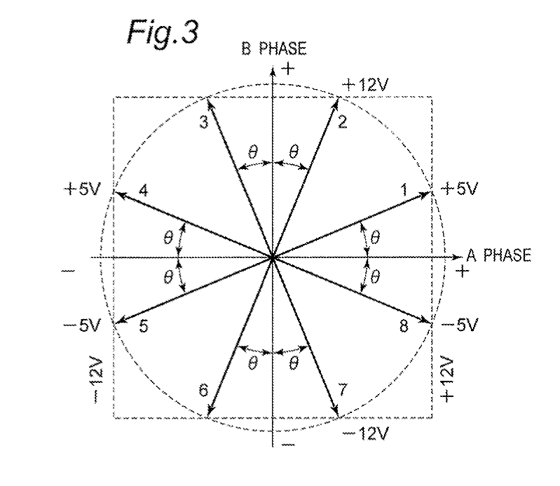

FIG. 3 shows drive vectors in the driving method (identical ratio excitation driving method) for the stepping motor drive apparatus according to the first embodiment of the present invention.

In FIG. 3, the directions of the vectors correspond to the positioning angles in an unloaded state. The direction of force in a state where solely the coil A13 is excited in an unloaded state is represented on the axis of A-phase+ direction (+ horizontal axis). Similarly, in FIG. 3, the direction of force in a state where solely the coil 814 is excited in an unloaded state is represented on the axis of B-phase+ direction (+ vertical axis).

In the stepping motor 11 of the stepping motor drive apparatus according to the first embodiment, though the direction of force that is generated at the rotor when the driving coil being the coil A13 is excited and that generated at the rotor when the driving coil being the coil B14 is excited actually form an angle of 18° (mechanical angle) between them, this is shown as 90° in FIG. 3. Further, the states from “state 1” to “state 8” in FIG. 2A are denoted by reference characters “1” to “8”, respectively, in FIG. 3.

As described in the foregoing, in the driving method of the stepping motor drive apparatus according to the first embodiment, a voltage of either “12 V” or “5V” is constantly applied to each of the two sets of driving coils, to drive the same. Accordingly, as shown in FIG. 3, the vectors of “state 1” to “state 8” each form an angle θ between the A-phase axis or the B-phase axis (the horizontal axis or the vertical axis). The angle θ is ideally tan 5/12≈22.5 (degrees). Therefore, as can clearly be seen from FIG. 3, every angle formed between adjacent vectors is 45° constantly. The angle of 45° is theoretically the same as the step angle in the normal 1-2 phase drive mode.

However, as to the step angle in the 1-2 phase drive mode, in an actual motor, the yoke is prone to magnetically saturate when the drive current of the yoke is increased. In addition, such an actual motor suffers the occurrence of displaced angle due to any load or the like. Therefore, generally, it is not always true that the step angle is driven by a constant angle of 45° even when the 1-2 phase drive mode is carried out with the theoretical ratio.

Generally, the A-phase coil and the yoke, and the B-phase coil and the yoke are manufactured to have the same configuration, and often, the same Components are used for them in common. Accordingly, when the direction of the drive current is reversed, the only difference is that the direction of generated magnetic field is reversed, and other than that, each coil and yoke still has totally the same characteristic. Further, as to the angle 90° formed between phase A and phase B perpendicular to each other, the actual mechanical angle of the stepping motor 11 in the first embodiment is 18°. The precision of this mechanical angle is mainly dependent on the mechanical assembly precision, and it is one of basic manufacturers' standard items of the stepping motor 11. Therefore, the precision of this mechanical angle has a certain level of guarantee.

Accordingly, in the driving method (identical ratio excitation driving method) for the stepping motor drive apparatus according to the first embodiment, as shown in FIG. 3, every angle θ formed relative to the A-phase coil axis or the B-phase coil axis assumes the same value. Further, because the A-phase coil axis and the B-phase coil axis are perpendicular to each other, even if an actual angle θ of 22.5° could not be derived from the theoretically obtained ratio (duty ratio d) value, by adjusting the value of the duty ratio such that the angle θ of 22.5 can be derived, every angle formed between adjacent vectors (step angle) can be set to 45° constantly.

The angle 45° formed between the vectors being set in this manner is an angle set in an unloaded state, such an angle will not vary even when the load varies, because the characteristic in each step is the same. Though the individual difference in characteristic among the stepping motors 11 varies depending on the drive current, the unique characteristic of a stepping motor 11 itself will not change when such a characteristic is once set so as to match with the stepping motor 11. Though the description is given herein of the stepping motor drive apparatus according to the first embodiment taking up an example in which setting is performed based on the theoretical value, adjustment is actually carried out so as to match with the respective characteristics of the stepping motors 11 themselves. Further, because the drive current can be known in advance, it is also possible to adjust the duty ratio d so as to match with the drive current.

Still further, in the driving method (identical ratio excitation driving method) for the stepping motor drive apparatus according to the first embodiment, the two sets of driving coils are constantly driven with an application of voltages “12 V” and “5 V”, and the A-phase coil and the yoke, and the B-phase coil and the yoke are similarly manufactured. Accordingly, when the direction of the drive current is reversed, the only difference is that the direction of generated magnetic field is reversed, and other than that, each coil and yoke still has totally the same characteristic. Accordingly, as shown in FIG. 3, the vectors in “state 1” to “state 8” are the same in magnitude. This means that the holding torque is the same throughout “state 1” to “state 8”, because the magnitude of the vector is related to the holding torque. This consistency of the holding torque will be described later. Such consistency of the holding torque throughout the drive states is highly advantageous in terms of precision in the drive state when actually loaded.

In the stepping motor 11, when the driving coils are energized, the rotor is held at a certain angular position in an unloaded state. In this hold state, no torque is produced. In this hold state, when torque is externally provided to displace the rotor from this angular position, torque (produced torque) commensurate to that displaced angle is produced in the direction to recover from the displacement. The relationship between the displaced angle and the produced torque is the stiffness characteristic mentioned above.

When the stepping motor 11 is used in an unloaded state, the stiffness characteristic is unrelated to the precision. However, when any load exists, the stiffness characteristic greatly affects the positioning precision. When loaded, the rotor does not stop at the same angular position as in an unloaded state, but the rotor stops at a position displaced by a displaced angle at which torque that balances with the load is produced. The angular position at which the rotor stops in such a case differs depending on the stiffness characteristic, even under the same load.

### [Stiffness Characteristic]

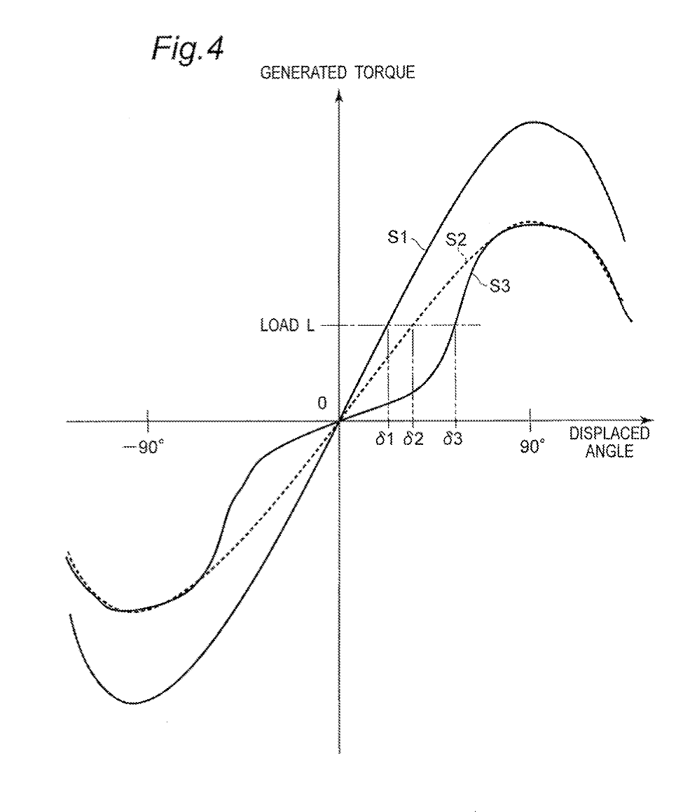

FIG. 4 is a graph showing the stiffness characteristic of the stepping motor 11 whose drive mode is controlled in the stepping motor drive apparatus according to the first embodiment of the present invention.

In FIG. 4, the horizontal axis represents the aforementioned displaced angle [degrees] in the electrical angle. The origin point represents the hold angular position when unloaded. The vertical axis in FIG. 4 represents the aforementioned produced torque.

In FIG. 4, the characteristic curve S1 represents the stiffness characteristic exhibited in the two-phase excitation state, which is the state where both the coil A13 and coil B14 are simultaneously excited at 12 V. Further, the characteristic curve S3 represents the stiffness characteristic exhibited in the one-phase excitation state, which is the state where one of the coil A13 and the coil B14 is solely excited at 12 V.

The stiffness characteristics of both the excitation states show that the produced torque increases in accordance with an increase in the displaced angle, and that the produced torque assumes the maximum value around a displaced angle of 90°, and declines thereafter.

As can clearly be seen from FIG. 4, the characteristic curve S1 of the two-phase excitation state and the characteristic curve S3 of the one-phase excitation state are not just different in the maximum value of the produced torque, but the characteristic curves themselves are different.

Accordingly, in the 1-2 phase excitation drive mode in the conventional stepping motor drive apparatus, the characteristic as being exhibited by the characteristic curve S1 of the two-phase excitation state and the characteristic as being exhibited by the characteristic curve S3 of the one-phase excitation state are alternately used. In the 1-2 phase excitation drive mode, for example when there exists a load of the torque indicated by load L in FIG. 4, the displaced angle is δ1 in the two-phase excitation state (characteristic curve S1), whereas the displaced angle is δ3 in the one-phase excitation state (characteristic curve S3). As shown in FIG. 4, the displaced angle δ1 in the two-phase excitation state and the displaced angle δ3 in the one-phase excitation state are greatly different from each other. In an unloaded state, the hold angular position is displaced by 45° in both the two-phase excitation state and the one-phase excitation state. However, when there exists the load L as shown in FIG. 4, the displaced angle occurring in response to the load L is different between the two-phase excitation state and the one-phase excitation state. Therefore, in the 1-2 phase excitation drive mode where the one-phase excitation state and the two-phase excitation state alternately occur, their respective step angles do not attain the angle of 45°, i.e., the rotational fluctuation occurs.

In order to prevent the occurrence of such a rotational fluctuation, in the conventional stepping motor drive apparatus disclosed in the aforementioned Japanese Unexamined Patent Application Publication Nos. 2000-125595, the drive voltage in the two-phase excitation state is lowered.

In FIG. 4, the characteristic curve S2 drawn as a broken line shows one exemplary stiffness characteristic as being exhibited when the drive voltage in the two-phase excitation state is lowered such that the maximum value of the produced torque in the two-phase excitation state assumes the same value as the maximum value of the produced torque in the one-phase excitation state, as in the excitation state in the conventional stepping motor drive apparatus disclosed in the Japanese Unexamined Patent Application Publication Nos. 2000-125595. As shown in FIG. 4, the characteristic curve S2 is in a shape of the characteristic curve S1 of the two-phase excitation state shrunk in the vertical direction. Thus, the displaced angle under the load L changes from δ1 to δ2, reaching near to δ3. However, originally, the characteristic curve S1 that provides the displaced angle δ1 and the characteristic curve S3 that provides the displaced angle δ3 are the different curves, not every displaced angle at every produced torque becomes identical, and the rotational fluctuation occur. It is possible to adjust the drive voltage such that the displaced angle δ2 in the two-phase excitation state and the displaced angle δ3 in the one-phase excitation state agree with each other at a specific produced torque. In such a case, no problem arises if the load stays constant. However, if the load varies, the displaced angle also varies to assume a different value. Therefore, eventually the rotational fluctuation occurs.

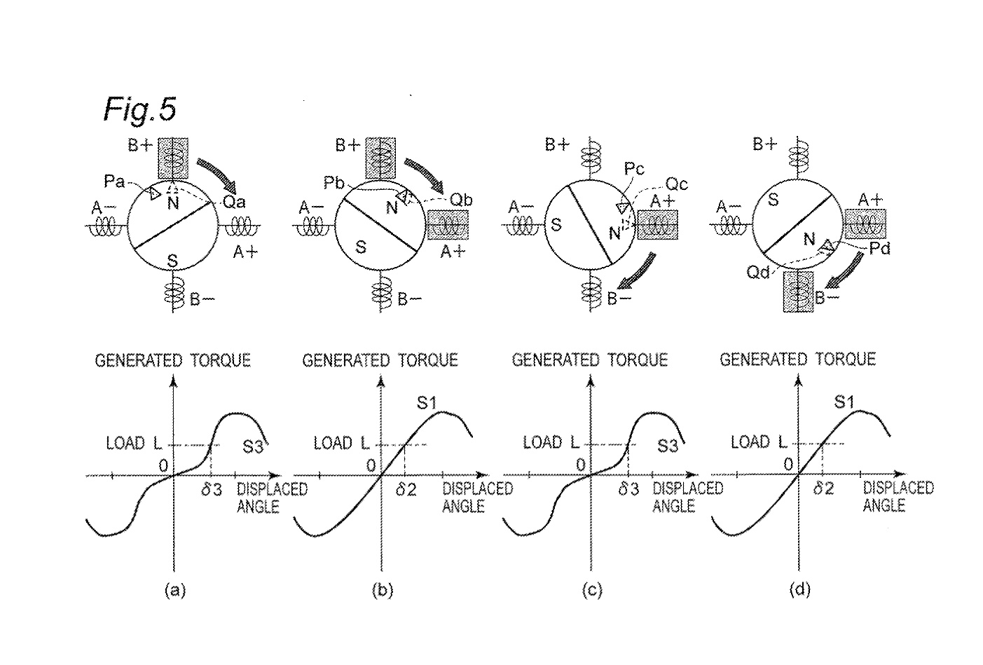

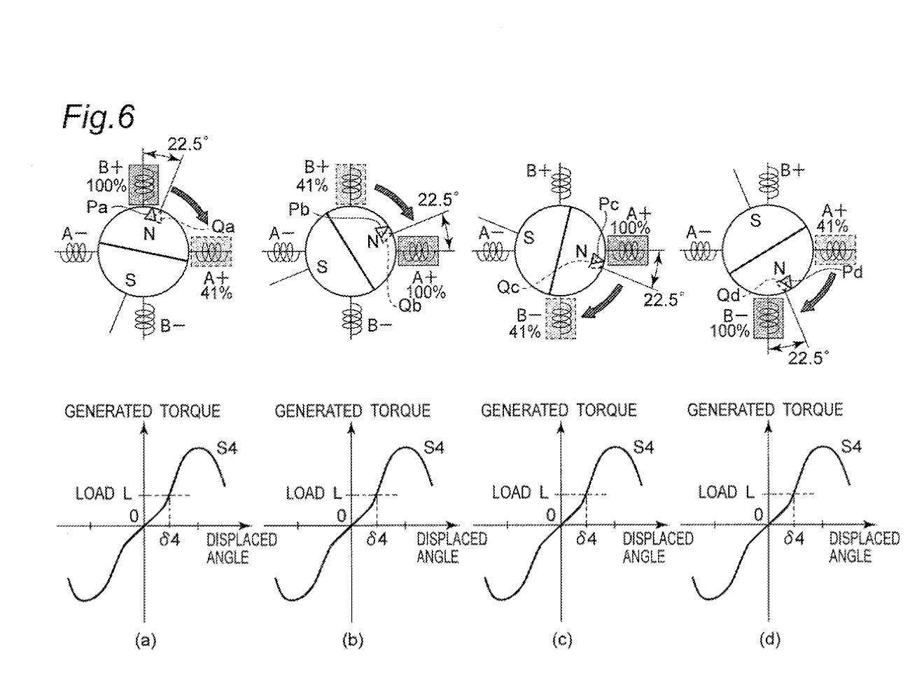

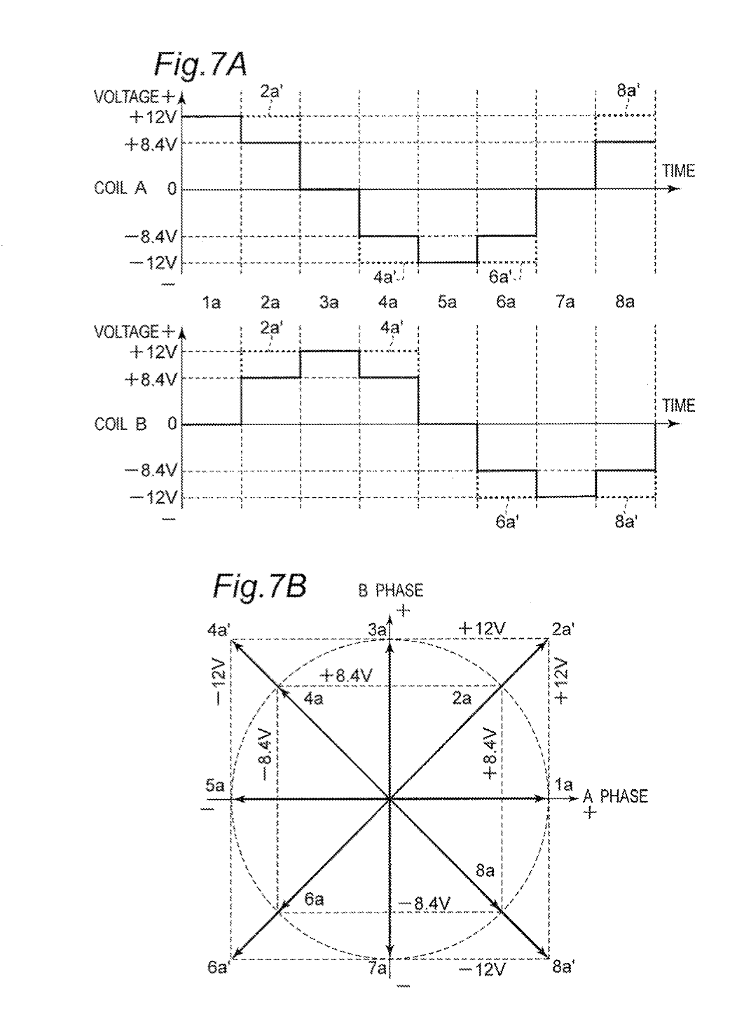

In the following, the operation (excitation) state in the 1-2 phase excitation drive mode in the conventional stepping motor drive apparatus and the operation (excitation) state in the stepping motor drive apparatus (identical ratio excitation driving method) according to the first embodiment of the present invention will be described in further detail, with reference to FIGS. 5 and 6. The conventional stepping motor drive apparatus described herein is configured to have the stiffness characteristic in a case where the drive voltage in the two-phase excitation state is lowered, such that the maximum value of the produced torque in the two-phase excitation state assumes the same value as the maximum value of the produced torque in the one-phase excitation state.

FIG. 5 shows the operation (excitation) states in the 1-2 phase excitation drive mode in the conventional stepping motor drive apparatus. The top row in FIG. 5 schematically shows the two phase sets of driving coils (the coil A (+, −) and the coil B (+, −)) and the rotor of each stepping motor, and the bottom row shows the characteristic curves of the stiffness characteristic in the 1-2 phase excitation drive mode corresponding to respective stepping motors in the top row.

In the 1-2 phase excitation drive mode shown in FIG. 5, (a) shows the state in which current is cause to flow such that the coil B+ side becomes the south pole and the coil B− side becomes the north pole so as to be excited (the one-phase excitation mode). (b) in FIG. 5 shows the state in which current is cause to flow such that the coil B+ side and the coil A+ side become the south pole, and the coil B− side and the coil A− side become the north pole so as to be excited (the two-phase excitation mode). Similarly, (c) in FIG. 5 shows the state in which current is cause to flow such that the coil A+ side becomes the south pole and the coil A− side becomes the north pole so as to be excited (the one-phase excitation mode). (d) in FIG. 5 shows the state in which current is cause to flow such that the coil A+ side and the coil B− side become the south pole and the coil A− side and the coil B+ side become the north pole so as to be excited (two-phase excitation mode). In the stepping motors shown in the top row in FIG. 5, the ideal angular positions of the rotor when unloaded are indicated by “Qa”, “Qb”, “Qc”, and “Qd”, and the angular positions containing actual displaced angles are indicated by “Pa”, “Pb”, “Pc”, and “Pd”.

As shown in (a) in FIG. 5, in the stiffness characteristic curve S3 in this one-phase excitation state, displaced angle δ3 is derived under the load L, and the rotor is at an angular position Pa with a great displacement amount from an ideal angular position Qa when unloaded. Next, the two-phase excitation state shown in (b) in FIG. 5 is entered, where the stiffness characteristic curve S2 provides the displaced angle of δ2 under the load L. Accordingly, the rotor is at an angular position Pb with a small displacement amount from an ideal angular position Qb. Next, the one-phase excitation state shown in (c) in FIG. 5 is entered, where the stiffness characteristic curve S3 provides the displaced angle δ3 under the load L. Accordingly, the rotor is at an angular position Pc with a great displacement amount from an ideal angular position Qc. In this manner, in the operational state in the 1-2 phase excitation drive, the one-phase excitation state and the two-phase excitation state alternate. Because the stiffness characteristic showing the relationship between the displaced angle and the produced torque is different between the one-phase excitation state and the two-phase excitation state, the phenomenon that the identical load (L) yields different displaced angles occurs. As a result, the operational state in the 1-2 phase excitation drive in the conventional stepping motor drive apparatus suffers the occurrence of the rotational fluctuation, failing to exert high-precision rotation position control.

FIG. 6 shows the operation (excitation) states in the identical ratio excitation driving method executed in the stepping motor drive apparatus according to the first embodiment of the present invention. The top row in FIG. 6 schematically shows the two phase sets of driving coils (the coil A (+, −) and the coil B (+, −)) and the rotor of each stepping motor, and the bottom row show the characteristic curves of the stiffness characteristic in the identical ratio excitation drive mode corresponding to respective stepping motors according to the first embodiment in the top row.

In the operational states in the identical ratio excitation driving method shown in FIG. 6, in the excitation state shown in (a), a voltage that is 100% as great as the absolute value of the supply voltage (for example, 12 V) is applied to the coil B, and current is caused to flow such that the coil B+ side becomes the south pole and the coil B− side becomes the north pole. Simultaneously herein, a voltage that is 41% as great as the absolute value of the supply voltage (for example, 5 V) is applied to the coil A, and current is caused to flow such that the coil A+ side becomes the south pole and the coil A− side becomes the north pole. The ideal angular position Qa of the rotor when unloaded in this situation is a position advanced by 22.5° from the coil B+ axis in the clockwise direction. However, the actual rotor is at the angular position Pa which is displaced in the counter-clockwise direction from the angular position Qa by the displaced angle δ4 when under the load L, based on the stiffness characteristic curve S4 in this state.

Next, the excitation state shown in (b) in FIG. 6 is entered, where a voltage as great as 41% of the absolute value of the supply voltage (for example, 5 V) is applied to the coil B, and current is caused to flow such that the coil B+ side becomes the south pole and the coil B− side becomes the north pole. Simultaneously herein, a voltage that is 100% as great as the absolute value of the supply voltage (for example, 12 V) is applied to the coil A, and current is caused to flow such that the coil A+ side becomes the south pole and the coil A− side becomes the north pole. The ideal angular position Qb of the rotor when unloaded in this situation is a position lagging behind by 22.5° from the coil A+ axis in the counter-clockwise direction. However, the actual rotor is at the angular position Pb which is displaced in the counter-clockwise direction from the angular position Qb by the displaced angle δ4 when under the load L, based on the stiffness characteristic curve S4 in this state. Accordingly, in the excitation state shown in (b) in FIG. 6, the rotor has shifted to the position by a rotation angle of 45° from the excitation state shown in (a) in FIG. 6.

Similarly, next, the excitation state shown in (c) in FIG. 6 is entered, where a voltage as great as 100% of the absolute value of the supply voltage (for example, 12 V) is applied to the coil A, and current is caused to flow such that the coil A+ side becomes the south pole and the coil A− side becomes the north pole. Simultaneously herein, a voltage that is 41% as great as the absolute value of the supply voltage (for example, 5 V) is applied to the coil B, and current is caused to flow such that the coil B− side becomes the south pole and the coil B+ side becomes the north pole. The ideal angular position Qc of the rotor when unloaded in this situation is a position advanced by 22.5° from the coil A+ axis in the clockwise direction. However, the actual rotor is at the angular position Pc which is displaced in the counter-clockwise direction from the angular position Qc by the displaced angle δ4 when under the load L, based on the stiffness characteristic curve S4 in this state. Accordingly, in the excitation state shown in (c) in FIG. 6, the rotor has shifted to the position by a rotation angle of 45° from the excitation state shown in (b) in FIG. 6. Next, the excitation state shown in (d) in FIG. 6 is entered, where the rotor has shifted to the position by a rotation angle of 45° from the excitation state shown in (c) in FIG. 6.

As described in the foregoing, the identical ratio excitation driving method for the stepping motor drive apparatus according to the first embodiment of the present invention is configured such that, the first drive signal DS1 having the first absolute value (for example, a voltage signal of 12 V, or a commensurate current signal (I1)) is applied to the driving coil of one phase, and a second drive signal DS2 having the second absolute value (for example, a voltage signal of 5 V, or a commensurate current signal (I2)) to the other driving coil, so that the two phase sets of driving coils are constantly in the same excitation state (i.e., the excitation state in which the ratio (d) between the first absolute value and the second absolute value is maintained at the same value). Accordingly, the stiffness characteristic showing the relationship between the displaced angle and the produced torque becomes constantly the same in any excitation state at any step position, whereby the same displaced angle is achieved at every step angle, achieving a configuration where the rotor can be held at a high-precision rotation angular position.

In the driving method (identical ratio excitation driving method) for the stepping motor drive apparatus according to the first embodiment of the present invention, as described in the foregoing, the two phase sets of driving coils are driven by constantly receiving application of the two types of voltages (drive signals DS1 and DS2), namely, of the first absolute value of “12 V” being 100% as great as the absolute value of the supply voltage (12 V), and of the second absolute value of “5 V” being about 41% (when the duty ratio d is 0.41) as great as the supply voltage. Further, the A-phase coil and the yoke, and the B-phase coil and the yoke are manufactured with the same configuration and structure and, therefore, when the direction of the drive current is reversed, the only difference is that the direction of generated magnetic field is reversed, and other than that, each coil and yoke still has totally the same characteristic. Accordingly, the stiffness characteristic is intrinsically the same characteristic throughout the drive states “state 1” to “state 8” in the stepping motor whose drive mode is controlled by the stepping motor drive apparatus according to the first embodiment of the present invention. Therefore, the displaced angle for the load assumes the same value throughout the drive states “state 1” to “state 8” even when the load varies, and the rotational fluctuation does not occur.

Generally, in connection with the seek operation of an optical pickup, the paper feed and the carriage shift in a printer apparatus and the like, the relevant load is mostly the friction load. Such a friction load greatly varies under a variety of conditions. Therefore, this characteristic of the stepping motor drive apparatus according to the present invention, that the rotational fluctuation occurs little despite variations in the load, is highly advantageous in terms of precision.

It is to be noted that, in connection with the stepping motor drive apparatus according to the first embodiment, it has been described that the ratio (d) value between the first absolute value and the second absolute value is constant. However, it may also be possible to configure such that the ratio is adjusted in accordance with the individual characteristics among stepping motors. Further, it may also be possible to configure such that the ratio (d) between the first absolute value and the second absolute value changes in accordance with the drive voltage or the drive current to the A− phase coil or the B-phase coil. Still further, it may also be possible to configure such that the ratio (d) between the first absolute value and the second absolute value changes depending on the number of rotation of the stepping motor. In this case, the ratio (d) may be changed such that the vibration of the stepping motor is minimized.

In connection with the stepping motor drive apparatus according to the first embodiment, the description has been given of the configuration in which the duty ratio d is set by the PWM signal generation unit 18, by which setting the drive voltage of the second absolute value (for example, 5 V) is obtained. However, in the present invention, it may also possible to configure to obtain the necessary drive voltage or any other voltage by a common bridged transformerless (BTL) drive circuit or the like.

The stepping motor drive apparatus according to the present invention may be configured to further include an adjustment apparatus that adjusts the ratio (d) between the first absolute value in the first drive signal DS1 and the second absolute value in the second drive signal DS2 in accordance with the usage state of the stepping motor.

The stepping motor drive apparatus of the present invention may be configured such that the drive control unit 15 switches between the two-phase drive mode and the microstep drive mode in accordance with the number of rotation, the precision of the rotation angular position, and the drive torque of the stepping motor to control the drive mode of the stepping motor. With such a configuration, by the identical ratio excitation driving method of the present invention, it becomes possible to carry out high-precision positioning, and alternatively, to select the two-phase drive mode at the expense of precision in a case where even greater drive torque is required and where the number of rotation is further increased. Additionally, it becomes possible to select the microstep drive mode in a case where high resolution is required with smooth rotation. Accordingly, it becomes possible to appropriately control the drive mode of the stepping motor in accordance with the usage state of the stepping motor.

Further, in connection with the stepping motor drive apparatus and the stepping motor driving method according to the first embodiment, the description has been given of the voltage control configuration of exerting control by switching the first drive signal DS1 having the first absolute value and the second drive signal DS2 having the second absolute value with respect to the coil A and the coil B of the two phases. However, it goes without saying that the stepping motor drive apparatus and the stepping motor driving method of the present invention can be configured in current control configuration of exerting control by switching the first drive signal DS1 having the absolute value of the drive current “I1” as the first absolute value and the second drive signal DS2 having the absolute value of the drive current “I2” as the second absolute value with respect to the coil A and the coil B of the two phases.

As in the foregoing, in the identical ratio excitation driving method for the stepping motor drive apparatus of the present invention, when the driving coil of one phase in the stepping motor is driven by the first drive signal DS1 of the first absolute value (I1), the driving coil of the other phase in the stepping motor is driven by the second drive signal DS2 of the second absolute value (I2). The ratio (d) between the first absolute value (I1) and the second absolute value (I2) is set such that the rotation angle per step stays at a constant value irrespective of the angular position, when the stepping motor is in an unloaded state. Specifically, the two-phase sets of driving coils of the stepping motor are constantly driven by the first drive signal having the first absolute value (I1) and the second drive signal having the second absolute value (I2). As a result, the two-phase sets of driving coils are constantly driven in the same excitation state and constantly have the same curve of the stiffness characteristic, wherein the sole difference is that the direction of current is different. Accordingly, even when the load varies, the same displaced angle is provided. Thus, it becomes possible to provide a stepping motor drive apparatus with which occurrence of the rotation angle variation is prevented.

According to the present invention, it becomes possible to provide a stepping motor drive apparatus that is free of rotation angle variation per step despite any variation in the load. Therefore, the present invention is useful when applied to high-precision shift mechanisms, such as the seek operation in an optical pickup, and paper feed or carriage shift in a printer apparatus.

What is claimed is:

1. A stepping motor drive apparatus, comprising a drive control unit that controls a drive mode of a stepping motor including driving coils respectively belonging to two phases, wherein
said drive control unit is configured to control the drive mode of said stepping motor by applying a first drive signal having a first absolute value to a driving coil belonging to one phase out of said driving coils respectively belonging to the two phases, and applying a second drive signal having a second absolute value to a driving coil belonging to other phase out of said driving coils respectively belonging to the two phases, and
said first absolute value and said second absolute value each have a value different from each other's, and a ratio between said first absolute value and said second absolute value is constant.

2. The stepping motor drive apparatus according to claim 1, wherein
the ratio between said first absolute value and said second absolute value in an unloaded state is set to achieve a constant rotation angle per step at every angular position in said stepping motor.

3. The stepping motor drive apparatus according to claim 1, wherein
a step position in said stepping motor is at an angular position displaced by −22.5° and +22.5° in electrical angle from an angular position when only the driving coil belonging to the one phase is excited in the unloaded state, and at an angular position displaced by −22.5° and +22.5° in electrical angle from an angular position when only the driving coil belonging to the other phase is excited in the unloaded state.

4. The stepping motor drive apparatus according to claim 1, wherein
said first absolute value and said second absolute value are variable values, and said ratio between said first absolute value and said second absolute value is adjusted in accordance with a characteristic of said stepping motor.

5. The stepping motor drive apparatus according to claim 1, further comprising an adjustment apparatus that adjusts said ratio in accordance with a usage state of said stepping motor.

6. The stepping motor drive apparatus according to claim 1, wherein
said drive control unit is configured to control the drive mode of said stepping motor by switching between a two-phase drive mode and a microstep drive mode in accordance with number of rotation, precision of a rotation angular position, and drive torque of said stepping motor.

7. A stepping motor driving method of controlling a drive mode of a stepping motor including driving coils respectively belonging to two phases, comprising a step of
controlling the drive mode of said stepping motor by applying a first drive signal having a first absolute value to a driving coil belonging to one phase out of said driving coils respectively belonging to the two phases, and applying a second drive signal having a second absolute value to a driving coil belonging to other phase out of said driving coils respectively belonging to the two phases, wherein
said first absolute value and said second absolute value each have a value different from each other's, and a ratio between said first absolute value and said second absolute value is constant.

8. The stepping motor driving method according to claim 7, wherein
the ratio between said first absolute value and said second absolute value in an unloaded state is set to achieve a constant rotation angle per step at every angular position in said stepping motor.

9. The stepping motor driving method according to claim 7, wherein
a step position in said stepping motor is at an angular position displaced by −22.5° and +22.5° in electrical angle from an angular position when only the driving coil belonging to the one phase is excited in the unloaded state, and at an angular position displaced by −22.5° and +22.5° in electrical angle from an angular position when only the driving coil belonging to the other phase is excited in the unloaded state.

10. The stepping motor driving method according to claim 7, wherein
said first absolute value or said second absolute value are variable values, and said ratio between said first absolute value and said second absolute value is adjusted in accordance with a characteristic of said stepping motor.

11. The stepping motor driving method according to claim 7, wherein
the step of controlling the drive mode of said stepping motor is performed by switching between a two-phase drive mode and a microstep drive mode in accordance with number of rotation, precision of a rotation angular position, and drive torque of said stepping motor.
